(19) United States
(12) Patent Application Publication
(10) Pub. No.: US 2013/0127930 A1
(43) Pub. Date: May 23, 2013

(54) VIDEO SIGNAL LINE DRIVING CIRCUIT AND DISPLAY DEVICE PROVIDED WITH SAME

(71) Applicant: Masaaki Nishio, Osaka-shi (JP)

(72) Inventor: Masaaki Nishio, Osaka-shi (JP)

(73) Assignee: SHARP KABUSHIKI KAISHA, Osaka-shi, Osaka (JP)

(21) Appl. No.: 13/813,363

(22) PCT Filed: Jun. 1, 2011
(86) PCT No.: PCT/JP2011/062582

§ 371 Date: Jan. 30, 2013

(30) Foreign Application Priority Data
Jul. 30, 2010 (JP) 2010-171712

(51) Int. Cl. G09G 3/36

(52) U.S. Cl. CPC G09G 3/3648
USPC 345/690; 345/89

(57) ABSTRACT

In this liquid crystal display device, typically, when a +3V source voltage VCI or a −3V source voltage VCI1 is present between a ground potential GND and an output signal voltage Dh, an output voltage selecting portion (305) is initially controlled to provide a video signal line with the +3V source voltage VCI or the −3V source voltage VCI1 (after providing the ground potential), thereby raising (or lowering) the potential of the video signal line. Thereafter, the video signal line is further driven at a voltage from a tone voltage generating circuit using a 5V power source until the potential level reaches the output signal voltage Dh. As a result, the 5V power source is used as little as possible so that power consumption can be reduced.

### RELATED APPLICATIONS

The present application is a National Phase of International Application Number PCT/JP2011/062582, filed Jun. 1, 2011, and claims priority from Japanese Application Number 2010-171712, filed Jul. 30, 2010.

### TECHNICAL FIELD

The present invention relates to active-matrix display devices, and more specifically, the invention relates to a video signal line driving circuit in an active-matrix liquid crystal display device.

### BACKGROUND ART

In general liquid crystal display devices, polarity inversion drive is performed to suppress liquid crystal deterioration. A known polarity inversion drive scheme is a scheme (frame inversion drive scheme) in which the polarity of a voltage applied to the liquid crystal is inverted every frame. However, this drive scheme is prone to display defects such as flicker upon display, and therefore, recently, there is employed a drive scheme (called a “line inversion drive scheme”) in which the polarity of an applied voltage is inverted every horizontal scanning signal line and also every frame, and there is another drive scheme (called a “dot inversion drive scheme”) in which the polarity of an applied voltage is inverted between any two vertically/horizontally adjacent pixels and is also inverted every frame.

The dot inversion drive scheme uses a relatively complicated anti-flickering pattern and therefore is resistant to flickering, so that high-quality display can be achieved.

Moreover, in this scheme, direct-current voltage is applied to a common electrode of a liquid crystal panel, and therefore, less noise occurs than in the scheme where the common electrode is driven by alternating-current voltage. This stabilizes the operation of a touch panel, which is a liquid crystal panel with an incorporated sensor.

However, in the dot inversion drive scheme where direct current voltage is applied to the common electrode as mentioned above, the polarity of a video signal to be applied to the liquid crystal panel is switched between predetermined higher and lower voltages with respect to the potential of the common electrode, and therefore, the voltage swing of a video signal outputted by a liquid crystal panel driver is large, so that a specialized power supply configuration is required and power consumption is prone to increase.

To suppress power consumption in such a dot inversion drive scheme, Japanese Laid-Open Patent publication No. 2006-154772 discloses a configuration where the polarity of a signal outputted by the source driver is inverted by temporarily providing a ground potential to the source driver. Such provision of the ground potential results in suppression of power consumption.

### CITATION LIST

### Patent Document

Patent Document 1: Japanese Laid-Open Patent Publication No. 2006-154772

### SUMMARY OF THE INVENTION

### Problems to be Solved by the Invention

In the case where the ground potential is simply provided as in the above conventional configuration, it is possible to suppress power consumption when the potential of the signal outputted by the source driver changes to the ground potential. However, for example, when the potential of the signal changes from positive to negative, and there is a significant difference between the ground potential and the negative potential of the signal, it is not possible to suppress power consumption due to such a change, so that power consumption cannot be considerably reduced.

Therefore, an objective of the present invention is to provide a video signal line driving circuit capable of considerably reducing power consumption and a liquid crystal display device including the same.

### Solution to the Problems

A first aspect of the present invention is directed to a video signal line driving circuit in a display device for receiving an image signal representing an image and applying voltages to a plurality of video signal lines in accordance with the image signal, the display device including pixel electrodes provided in a plurality of pixel forming portions arranged in a matrix so as to correspond to intersections of the video signal lines and a plurality of scanning signal lines in a display portion for displaying the image, a common electrode opposed to the pixel electrodes so as to apply voltage to the pixel electrodes, a first power source for providing a first voltage, and a second power source for providing a second voltage having a greater magnitude than the first voltage, the driving circuit comprising:

a tone voltage generating circuit for generating a plurality of tone voltages to be applied to the video signal lines based on the second power source;

a conversion circuit for converting the generated tone voltages and outputting signals indicative of pixel values included in the image signal that are to be provided to the pixel forming portions; and

an output circuit for providing a signal voltage outputted by the conversion circuit to a target video signal line for supplying the pixel forming portion with a signal voltage to be outputted by the conversion circuit when a threshold voltage that is set in accordance with the first voltage is not present between the signal voltage to be outputted by the conversion circuit and an immediately previous voltage of the target video signal line, wherein the output circuit provides the first voltage to the target video signal line during a first predetermined period when the threshold voltage is present, and after a lapse of the first period, the output circuit provides the signal voltage outputted by the conversion circuit to the target video signal line.

In a second aspect of the present invention, based on the first aspect of the invention, the tone voltage generating circuit generates a plurality of tone voltages including positive and negative voltages relative to a constant potential of the common electrode, every predetermined polarity inversion period, the conversion circuit alternatingly selects a positive or negative tone voltage corresponding to the image signal from the generated tone voltages, and outputs the selected voltage such that the polarity of the voltage applied to the pixel electrode relative to a constant potential is inverted every predetermined polarity inversion period, the constant potential being a potential equal or close to the potential of the common electrode, and when the constant potential is present between the signal voltage outputted by the conversion circuit and the immediately previous voltage of the target video signal line, the output circuit provides the constant potential to the target video signal line during a second predetermined period, and after a lapse of the second period, the output circuit provides the signal voltage outputted by the conversion circuit to the target video signal line.

In a third aspect of the present invention, based on the second aspect of the invention, when the constant potential is present between the signal voltage outputted by the conversion circuit and the immediately previous voltage of the target video signal line, and the threshold voltage is present between the constant potential and the signal voltage outputted by the conversion circuit, the output circuit provides the target video signal line with the constant potential during the second period, the first voltage during the first period immediately after a lapse of the second period, and then the signal voltage outputted by the conversion circuit after a lapse of the first period.

In a fourth aspect of the present invention, based on the third aspect of the invention, the conversion circuit alternatingly selects a positive or negative tone voltage relative to the constant potential, and outputs the selected voltage such that the polarities of pixel electrodes provided in two adjacent pixel forming portions respectively are different and inverted, and the output circuit provides the target video signal line with the constant potential during the second period, and also provides the target video signal line with the first voltage during the first period immediately after a lapse of the second period, and then the signal voltage outputted by the conversion circuit after a lapse of the first period, when the threshold voltage is present between the constant potential and the signal voltage outputted by the conversion circuit.

In a fifth aspect of the present invention, based on the first aspect of the invention, the magnitude of the threshold voltage is close to but greater than the magnitude of the first voltage.

A sixth aspect of the present invention is directed to an active-matrix display device, comprising:

a video signal line driving circuit of the first aspect of the invention;

a scanning signal line driving circuit for selectively driving the scanning signal lines;

a display control circuit for generating tone signals indicative of tones that correspond to an image signal representing the image and provided from outside the device; and

a common electrode driving circuit for providing a predetermined potential to the common electrode.

A seventh aspect of the present invention is directed to a method for driving a video signal line in a display device by receiving an image signal representing an image and applying voltages to a plurality of video signal lines in accordance with the image signal, the display device including pixel electrodes provided in a plurality of pixel forming portions arranged in a matrix so as to correspond to intersections of the video signal lines and a plurality of scanning signal lines in a display portion for displaying the image, a common electrode opposed to the pixel electrodes so as to apply voltage to the pixel electrodes, a first power source for providing a first voltage, and a second power source for providing a second voltage having a greater magnitude than the first voltage, the method comprising:

a tone voltage generation step of generating a plurality of tone voltages to be applied to the video signal lines based on the second power source;

a conversion step of converting the generated tone voltages and outputting signals indicative of pixel values included in the image signal that are to be provided to the pixel forming portions; and

an output step of providing a signal voltage outputted in the conversion step to a target video signal line for supplying the pixel forming portion with a signal voltage to be outputted in the conversion step when a threshold voltage that is set in accordance with the first voltage is not present between the signal voltage to be outputted in the conversion step and an immediately previous voltage of the target video signal line, wherein the first voltage is provided to the target video signal line during a first predetermined period when the threshold voltage is present, and after a lapse of the first period, the signal voltage outputted by the conversion step is provided to the target video signal line.

### Effect of the Invention

According to the first aspect of the invention, when the threshold voltage is present between the signal voltage to be outputted by the conversion circuit and the immediately previous voltage of the target video signal line, the target video signal line is provided with the first voltage during the first predetermined period, and then provided with the signal voltage outputted by the conversion circuit after a lapse of the first period, and therefore, after the first voltage is initially provided to the video signal line to raise (or lower) the potential of the video signal line, the video signal line is driven by the tone voltage generating circuit in accordance with the second power source until the potential reaches the signal voltage to be outputted, so that power consumption can be reduced.

According to the second aspect of the invention, when the constant potential is present between the signal voltage outputted by the conversion circuit and the immediately previous voltage of the target video signal line, the target video signal line is provided with the constant potential during the second predetermined period, and then provided with the signal voltage outputted by the conversion circuit after a lapse of the second period, and therefore, after the video signal line is provided with the first voltage and then the constant potential so that the potential thereof is raised (or lowered), the video signal line is driven by the tone voltage generating circuit in accordance with the second power source until the potential reaches the signal voltage to be outputted, so that power consumption can be reduced.

According to the third aspect of the invention, when the constant potential is present between the signal voltage outputted by the conversion circuit and the immediately previous voltage of the target video signal line, and the threshold voltage is present between the constant potential and the signal voltage outputted by the conversion circuit, the target video signal line is provided with the constant potential during the second period, the first voltage during the first period after a lapse of the second period, and then the signal voltage outputted by the conversion circuit after a lapse of the first period, and therefore, after the video signal line is provided with the constant potential to raise (or lower) the potential thereof, and then provided with the first potential to further raise (or lower) the potential, the video signal line is driven by the tone voltage generating circuit in accordance with the second power source until the potential reaches the signal voltage to be outputted, so that power consumption can be reduced.

According to the fourth aspect of the invention, a so-called 1-dot inversion drive scheme is employed, and after the video signal line is necessarily provided with the constant potential to raise (or lower) the potential thereof, and then, where necessary, the first potential to further raise (or lower) the potential, the video signal line is driven by the tone voltage generating circuit in accordance with the second power source until the potential reaches the signal voltage to be outputted, so that power consumption can be reduced.

According to the fifth aspect of the invention, the magnitude of the threshold voltage is close to but greater than the magnitude of the first voltage, and therefore, the potential of the video signal line is raised (or lowered) beyond the first voltage, but consequently, the period in which to drive the video signal line by the tone voltage generating circuit in accordance with the second power source can be shortened, so that power consumption can be further reduced.

According to the sixth aspect of the invention, the display device can achieve similar effects to those achieved by the first aspect of the invention.

According to the seventh aspect of the invention, the video signal line driving method can achieve similar effects to those achieved by the first aspect of the invention.

### BRIEF DESCRIPTION OF THE DRAWINGS

FIG. 1 is a block diagram illustrating the configuration of a liquid crystal display device according to an embodiment of the present invention.

FIG. 2 is a block diagram illustrating the configuration of a display control circuit in the embodiment.

FIG. 3 is a schematic diagram illustrating the configuration of a liquid crystal panel in the embodiment.

FIG. 4 is an equivalent circuit diagram of a part of the liquid crystal panel in the embodiment.

FIG. 5 is a block diagram illustrating the configuration of a video signal line driving circuit in the embodiment.

FIG. 6 is a diagram describing details of a D/A conversion circuit included in a D/A conversion portion in the embodiment.

FIG. 7 is a block diagram illustrating details of a timing control portion in the embodiment.

FIG. 8 is a diagram schematically illustrating waveforms of a scanning signal, a drive video signal, and voltage selection signals where a 3V power circuit is used in the embodiment.

FIG. 9 is a diagram schematically illustrating waveforms of a scanning signal, a drive video signal, and voltage selection signals where the 3V power circuit is not used in the embodiment.

FIG. 10 is a schematic diagram illustrating the configuration of a liquid crystal panel in a second embodiment of the present invention.

FIG. 11 is a block diagram illustrating the configuration of a display control circuit in the embodiment.

FIG. 12 is a flowchart illustrating the flow of the procedure for a timing control circuit to determine a voltage selection specification signal Cs in the embodiment.

FIG. 13 is a flowchart illustrating in detail the flow of the procedure for a VCI necessity determination process in the embodiment.

FIG. 14 is a table showing conditions under which to determine whether or not to set a +3V source voltage VCI in a VCI intervention determination process of the embodiment.

FIG. 15 is a diagram schematically illustrating waveforms of a scanning signal, a drive video signal, and voltage selection signals where a 3V power circuit is used in the embodiment.

FIG. 16 is a diagram schematically illustrating waveforms of a common potential and a drive video signal where a 3V power circuit is used in a variant of the embodiment.

### MODES FOR CARRYING OUT THE INVENTION

Hereinafter, embodiments of the present invention will be described with reference to the accompanying drawings.

### 1. First Embodiment

<1.1 Overall Configuration and Operation>

FIG. 1 is a block diagram illustrating the configuration of a liquid crystal display device according to a first embodiment of the present invention. This liquid crystal display device is, for example, a display device for a mobile terminal device such as a notebook computer, and includes a display control circuit 200, a video signal line driving circuit 300, a scanning signal line driving circuit 400, a common electrode driving circuit 500, an active-matrix liquid crystal panel 600, and a reference voltage generating circuit 700 for providing the video signal line driving circuit 300 with a predetermined voltage to be referenced.

Note that the liquid crystal display device is configured differently from conventional devices in that the video signal line driving circuit 300 is controlled such that its output voltage is set at a constant ground potential or a predetermined source voltage. Details thereof will be described later.

Furthermore, FIG. 1 shows the above circuits as being discrete circuits, but one or more integrated circuit chips each including two or more of the circuits may be mounted on the liquid crystal panel. For example, the display control circuit 200 and the video signal line driving circuit 300 may be formed in different integrated circuit chips or in the same chip (typically, a source driver IC). Moreover, part or all of the above circuits may be integrally (monolithically) formed on a glass substrate of the liquid crystal panel.

Here, in general liquid crystal display devices, polarity inversion drive is performed to suppress liquid crystal deterioration and maintain display quality. A known polarity inversion drive scheme is a scheme (frame inversion drive scheme) in which the polarity of a voltage applied to a liquid crystal is inverted every frame. However, this scheme is prone to display defects such as flicker upon display, and therefore, recently, there is employed a scheme (called a “line inversion drive scheme”) in which the polarity of an applied voltage is inverted every horizontal scanning signal line and also every frame, and there is another scheme (called a “dot inversion drive scheme”) in which the polarity of an applied voltage is inverted between any two vertically/horizontally adjacent pixels and is also inverted every frame. The liquid crystal display device of the present embodiment employs the dot inversion drive scheme.

The liquid crystal panel 600, which is a display unit of the liquid crystal display device, includes a plurality of scanning signal lines (row electrodes) respectively corresponding to horizontal scanning lines of an image represented by image data Dv received from a predetermined external video source (CPU or suchlike), a plurality of video signal lines (column electrodes) crossing each of the scanning signal lines, and a plurality of pixel forming portions provided so as to correspond to intersections of the scanning signal lines and the video signal lines. The pixel forming portion is configured basically in the same manner as in conventional active-matrix liquid crystal panels (details will be described later).

Furthermore, the liquid crystal panel 600 includes a common electrode, which is commonly provided for pixel electrodes included in the pixel forming portions, so as to be opposed to the pixel electrodes with respect to a liquid crystal layer. Note that this is a typical example of the arrangement of the pixel electrodes and the common electrode to apply voltage to the liquid crystal layer, and since electrode planes of these electrodes do not have to be opposed to each other so long as voltage can be applied to the liquid crystal layer, the electrodes may be arranged in the same plane so that their sides are opposed to each other as in, for example, a so-called IPS (in-plane switching) mode.

In the present embodiment, image data Dv representing an image to be displayed on the liquid crystal panel 600 and an address signal ADw (referred to below as a “display control signal ADw”), which is a timing signal for display operation, are sent from the external video source to the display control circuit 200.

On the basis of the display control signal ADw and the image data Dv, the display control circuit 200 generates various signals, including a source clock signal SCK and a source start pulse signal SSP, which are provided to the video signal line driving circuit 300 for display on the liquid crystal panel, as well as a gate clock signal GCK and a gate start pulse signal GSP, which are provided to the scanning signal line driving circuit 400 for display. Since these signals are known, any descriptions thereof will be omitted. The display control circuit 200 receives video data from the external video source, writes the data to display memory, and then reads and outputs the data to be used by the source driver. In addition, based on the clock signals and so on, the display control circuit 200 generates a polarity switching control signal φ for polarity inversion drive of the liquid crystal panel 600. In this manner, among the signals generated by the display control circuit 200, a digital image signal Da and the polarity switching control signal φ are supplied to the video signal line driving circuit 300.

In addition to data representing an image to be displayed on the liquid crystal panel 600, which is supplied in units of pixels as the digital image signal Da, the video signal line driving circuit 300 is supplied with timing signals, including the source clock signal SCK, the source start pulse signal SSP, the polarity switching control signal φ, and so on, as described above. Based on the digital image signal Da, the source clock signal SCK, the source start pulse signal SSP, the polarity switching control signal φ, and so on, the video signal line driving circuit 300 generates analog voltages (also referred to below as “drive video signals”) D(1), D(2), D(3), and so on, to drive the liquid crystal panel 600, and applies the voltages to the video signal lines of the liquid crystal panel 600. For polarity inversion drive of the liquid crystal panel 600, the drive video signals D(1), D(2), D(3), and so on, have their polarities inverted in accordance with the polarity switching control signal φ. In addition, as will be described later, the drive video signals D(1), D(2), D(3), and so on, are characterized by (gradually) changing to one or more predetermined potentials, at least including a ground potential GND (or a corresponding constant potential), and ultimately to a potential corresponding to the digital image signal Da.

Note that the ground potential GND herein is typically 0V, but it widely refers to any constant potential that can be actually taken as a ground potential, including a constant potential close to 0V. For example, in the case of a well-known charge sharing drive mode, which is often employed in the dot inversion drive scheme, the potential of each video signal line during charge sharing (typically, an average potential among all video signal lines) may be set as the ground potential GND.

On the basis of the gate clock signal GCK and the gate start pulse signal GSP, the scanning signal line driving circuit 400 generates scanning signals G(1), G(2), G(3), and so on, to be applied to the scanning signal lines of the liquid crystal panel 600 and thereby to select each of the scanning signal lines for one horizontal scanning period in a predetermined order to be described later, and repeats application of active scanning signals to the scanning signal lines in cycles of one vertical scanning period, thereby sequentially selecting all of the scanning signal lines.

The common electrode driving circuit 500 generates a common voltage Vcom, which is a voltage to be provided to the common electrode of the liquid crystal panel 600. Specifically, in the present embodiment, the common electrode driving circuit 500 generates a constant reference voltage (here, −0.5V) slightly lower than the ground voltage, and supplies it to the common electrode of the liquid crystal panel 600 as the common voltage Vcom. Note that the common electrode driving circuit 500 receives a +3V source voltage VCI and a −3V source voltage VCI1 from a 3V power circuit not shown in FIG. 1, and generates the common voltage Vcom on the basis of these voltages.

In this manner, the liquid crystal panel 600 has the drive video signals D(1), D(2), D(3), and so on, applied to the video signal lines by the video signal line driving circuit 300 in accordance with the digital image signal Da and so on, and the liquid crystal panel 600 also has the scanning signals G(1), G(2), G(3), and so on, applied to the scanning signal lines by the scanning signal line driving circuit 400, and the common voltage Vcom applied to the common electrode by the common electrode driving circuit 500. As a result, the liquid crystal panel 600 displays the image represented by the image data Dv received from the external video source.

The reference voltage generating circuit 700 generates a plurality of reference voltages Vr to be referenced when the video signal line driving circuit 300 generates drive video signals to provide a display screen with predetermined tones, and the reference voltage generating circuit 700 provides the generated reference voltages Vr to the video signal line driving circuit 300. The video signal line driving circuit 300 generates drive video signals on the basis of the reference voltages Vr, and this operation will be described later.

<1.2 Display Control Circuit>

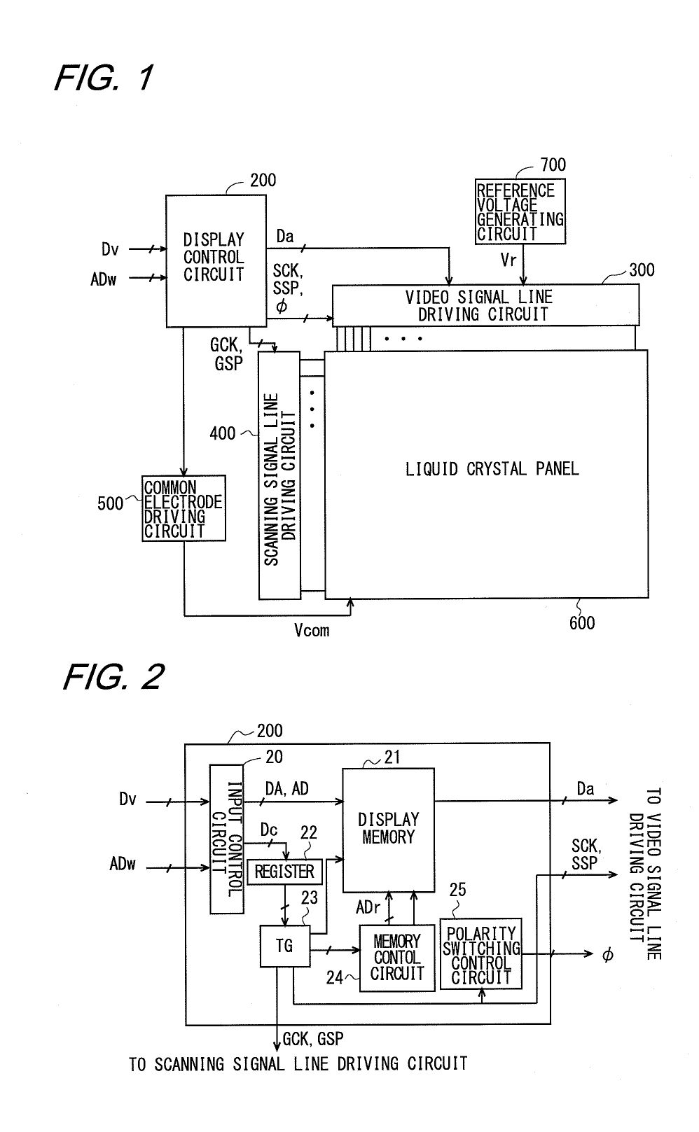

FIG. 2 is a block diagram illustrating the configuration of the display control circuit 200 in the above liquid crystal display device. The display control circuit 200 includes an input control circuit 20, display memory 21, a register 22, a timing generating circuit 23, a memory control circuit 24, and a polarity switching control circuit 25.

The image data Dv and the display control signal ADw received by the display control circuit 200 from the external video source are sorted by the input control circuit 20 as image data DA and display control data Dc, so that the image data DA is written to the display memory 21, and the display control data Dc to the register 22.

On the basis of the display control data held in the register 22, the timing generating circuit (abbreviated below as “TG”) 23 generates a source clock signal SCK, a source start pulse signal SSP, a gate clock signal GCK, a gate start pulse signal GSP, and other timing signals.

The memory control circuit 24 controls the operation of the display memory 21. In accordance with the control, a digital image signal Da representing an image to be displayed on the liquid crystal panel 600 is read from the display memory 21, and then outputted from the display control circuit 200. The digital image signal Da is supplied to the video signal line driving circuit 300, as has already been described.

On the basis of the gate clock signal GCK and the gate start pulse signal GSP generated by the TG 23, the polarity switching control circuit 25 generates the aforementioned polarity switching control signal φ. The polarity switching control signal φ is a control signal for determining the timing of polarity inversion for the polarity inversion drive of the liquid crystal panel 600, and is supplied to the video signal line driving circuit 300, as has already been described.

<1.3 Liquid Crystal Panel>

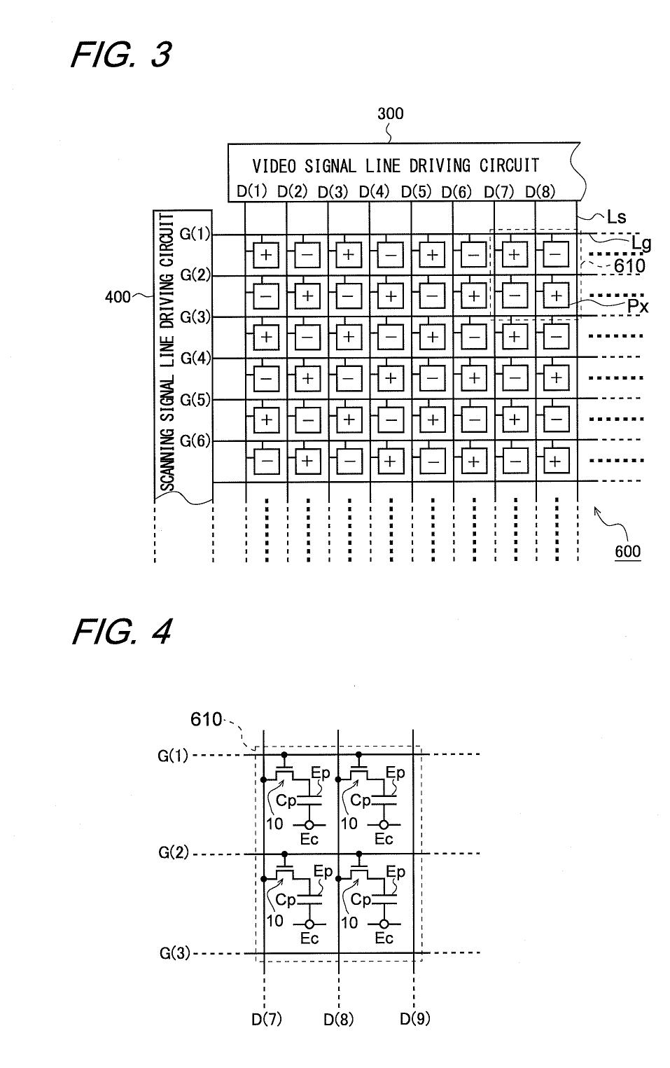

FIG. 3 is a schematic diagram illustrating the configuration of the liquid crystal panel 600 in the present embodiment, and FIG. 4 is an equivalent circuit diagram of a part 610 (corresponding to four pixels) of the liquid crystal panel.

The liquid crystal panel 600 includes a plurality of video signal lines Ls connected to the video signal line driving circuit 300, and a plurality of scanning signal lines Lg connected to the scanning signal line driving circuit 400, and the video signal lines Ls and the scanning signal lines Lg are arranged in a grid pattern so as to cross each other. Moreover, a plurality of pixel forming portions Px are provided so as to correspond to intersections of the video signal lines Ls and the scanning signal lines Lg. As shown in FIG. 4, each pixel forming portion Px includes a TFT (thin-film transistor) 10, which has a source terminal connected to the video signal line Ls passing through its corresponding intersection and a gate terminal connected to the scanning signal line Lg passing through that intersection, a pixel electrode Ep connected to a drain terminal of the TFT 10, a common electrode (also referred to as an “opposing electrode”) Ec commonly provided for the pixel forming portions Px, and a liquid crystal layer commonly provided for the pixel forming portions Px between the pixel electrode Ep and the common electrode Ec. In addition, the pixel electrode Ep, the common electrode Ec, and the liquid crystal layer provided therebetween form a pixel capacitance Cp. Note that as can be appreciated from the above configuration, when a scanning signal G(k) applied to any one of the scanning signal lines Lg is activated, that scanning signal line is selected, so that the TFT 10 (of each pixel forming portion Px) connected thereto is made conductive, and the pixel electrode Ep connected to the TFT 10 has a drive video signal D(j) applied through the video signal line Ls. As a result, the voltage of the applied drive video signal D(j) (relative to the potential of the common electrode Ec) is written to the pixel forming portion Px including that pixel electrode Ep as a pixel value. Note that the voltage of the drive video signal D(j) is characterized by gradually changing to one or more predetermined potentials, at least including the ground potential GND, and ultimately to a potential corresponding to the digital image signal Da, as will be described later.

The pixel forming portions Px as described above are arranged in a matrix to form a pixel forming matrix, and correspondingly, the pixel electrodes Ep included in the pixel forming portions Px are also arranged in a matrix to form a pixel electrode matrix. Incidentally, the pixel electrode Ep, which is a main part of the pixel forming portion Px, has one-to-one correspondence with a pixel in an image displayed on the liquid crystal panel and thus can be considered the same as the pixel. Accordingly, for convenience of explanation, in the following, the pixel forming portion Px or the pixel electrode Ep will be considered the same as the pixel, and the “pixel forming matrix” or the “pixel electrode matrix” will also be simply referred to as the “pixel matrix”.

In FIG. 3, “+” assigned to pixel forming portions Px denotes positive voltages (relative to the common electrode Ec) being applied to the pixel liquid crystal (i.e., the pixel electrodes Ep) included in the pixel forming portions Px during a certain frame, “−” assigned to pixel forming portions Px denotes negative voltages (relative to the common electrode Ec) being applied to the pixel liquid crystal (i.e., the pixel electrodes Ep) included in the pixel forming portions Px during that frame, and in this manner, a polarity pattern in the pixel matrix is shown by “+” and “−” assigned to the pixel forming portions Px. As shown in FIG. 3, the present embodiment employs the dot inversion drive scheme, which is a drive scheme where the polarity of a voltage applied to the pixel liquid crystal is inverted between any two vertically/horizontally adjacent pixels in the matrix and is also inverted every frame.

<1.4 Video Signal Line Driving Circuit>

<1.4.1 Configuration of the Video Signal Line Driving Circuit>

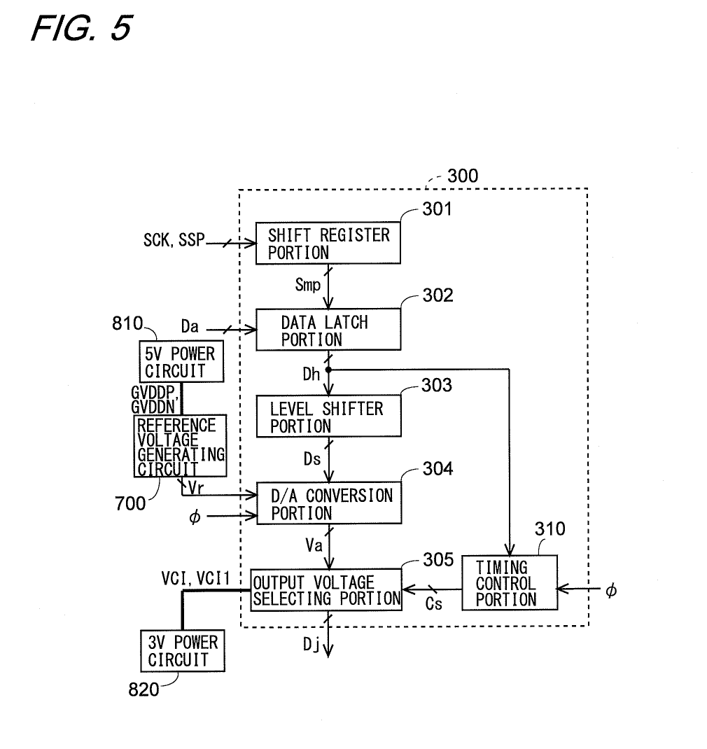

FIG. 5 is a block diagram illustrating the configuration of the video signal line driving circuit 300. Hereinafter, each component will be described with reference to FIG. 5. The video signal line driving circuit 300 includes a shift register portion 301 for receiving a source clock signal SCK and a source start pulse signal SSP outputted by the display control circuit 200 shown in FIG. 1 and outputting a predetermined sampling pulse Smp, a data latch portion 302 for receiving a digital image signal Da outputted by the display control circuit 200 and the sampling pulse Smp and latching data that indicates pixel values included in the digital image signal Da, a level shifter portion 303 for shifting a signal voltage of the data latched by the data latch portion 302, a D/A conversion portion 304 for converting the digital data signal with its voltage shifted by the level shifter portion 303 to an analog voltage signal, an output voltage selecting portion 305 for selecting either the analog voltage signal from the D/A conversion portion 304 or any one of a plurality of predetermined voltages to be described later, and applying the selection to a corresponding video signal line Ls, and timing control portions 310 for providing output voltage selecting portion 305 with voltage selection specification signals Cs, which specify voltages to be selected, in accordance with the data received from the data latch portion 302. These components, excluding the output voltage selecting portion 305 and the timing control portions 310, are approximately the same as those used in conventional video signal line driving circuits. The operation of each component will be described below with reference to FIG. 5.

<1.4.2 Operation of the Video Signal Line Driving Circuit>

The shift register portion 301 is configured by connecting a plurality of flip-flop circuits as serial stages, such that the stages sequentially transfer the source start pulse signal SSP in synchronization with the source clock signal SCK, thereby sequentially outputting predetermined sampling pulses Smp.

The data latch portion 302 includes a plurality of latch circuits provided one for each stage of the shift register portion 301, so that data included in the digital image signal Da is sampled in accordance with the sampling pulses Smp, and thereafter continuously outputted for a predetermined period of time. Specifically, digital data provided to pixel forming portions Px in a certain row (e.g., the first row) of the pixel matrix is temporarily stored in a sampling memory circuit (not shown) included in the data latch portion 302, and the stored data is provided to a hold memory circuit (not shown) included in the data latch portion 302. The hold memory circuit takes in output signals from stages of its corresponding sampling memory circuit upon the rise of a predetermined latch signal, and provides the output signals to the level shifter portion 303 and the timing control portion 310 as output signals Dh.

The level shifter portion 303 includes a plurality of level shifter circuits provided one for each stage of the shift register portion 301, so that the output signals Dh received from the data latch portion 302 are outputted as level shifter signals Ds after each of their voltage levels is shifted (in general, raised) to an appropriate input signal level for the D/A conversion portion 304.

The D/A conversion portion 304 includes a plurality of D/A conversion circuits provided one for each stage of the shift register portion 301, so that received level shifter signals Ds, which are output digital signals from the level shifter portion 303, are converted to analog voltage signals Va corresponding to the digital data. Specifically, from among multiple types of analog voltages (referred to below as “tone voltages”) generated for gradation display in accordance with a plurality of reference voltages Vr from the reference voltage generating circuit 700, the D/A conversion portion 304 selects a corresponding tone voltage for each of the received digital signals, and outputs the selected voltage as an analog voltage signal Va.

Note that on the basis of a −5V source voltage GVDDN and a +5V source voltage GVDDP provided by a 5V power circuit 810, the reference voltage generating circuit 700 generates the reference voltages Vr (e.g., through resistance division of the source voltages). The configuration of the reference voltage generating circuit 700 is well known. Moreover, the reason for the D/A conversion portion 304 to be provided with the reference voltages Vr from the reference voltage generating circuit 700 is to more accurately set tone voltages to be generated by the D/A conversion portion 304, and such a configuration where the D/A conversion portion 304 is provided with a plurality of reference voltages is also well known.

Here, (positive and negative) tone voltage generating circuits for generating all tone voltages may be provided in place of the reference voltage generating circuit 700, and the D/A conversion circuit may be a selector circuit for selecting one of the tone voltages from the tone voltage generating circuits in accordance with a received level shifter signal Ds.

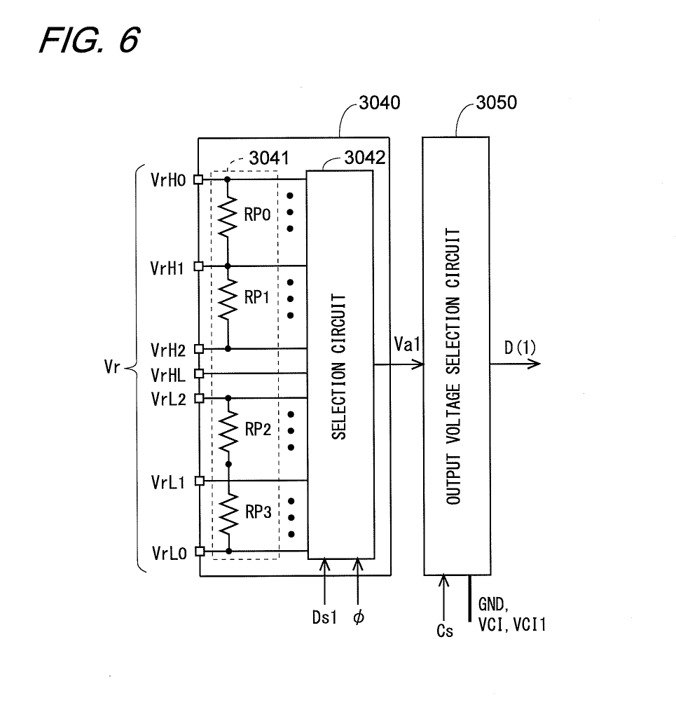

The output voltage selecting portion 305 includes a plurality of output buffer circuits (typically, voltage follower circuits) provided one for each stage of the shift register portion 301, so that the analog voltage signal Va, the ground voltage GND, and either the +3V source voltage VCI or the −3V source voltage VCI1 provided by a 3V power circuit 820 are selected during a period specified by a voltage selection specification signal Cs received from the timing control portion 310, and outputted to the video signal line Ls via the output buffer circuit as video signals Dj. Note that the determination of selecting either the +3V source voltage VCI or the −3V source voltage VCI1 is made in accordance with a polarity switching control signal φ. Moreover, the three voltages are provided through three voltage supply lines (specifically, a +3V voltage supply line, a −3V voltage supply line, and a ground voltage supply line, all of which are not shown) commonly provided for the stages of the shift register portion 301. Next, the configuration of the D/A conversion portion 304 and the operation of the output voltage selecting portion 305 will be described in detail with reference to FIG. 6.

<1.4.3 Configuration and Operation of the D/A Converting Portion>

FIG. 6 is a diagram describing details of a D/A conversion circuit 3040 included in the D/A conversion portion 304, along with associated components. The D/A conversion circuit 3040 shown in FIG. 6 is a D/A conversion circuit provided so as to correspond to the first stage of the shift register portion 301. An output voltage selection circuit 3050 is a voltage selection circuit provided so as to correspond to the first stage. Note that all D/A conversion circuits and all voltage selection circuits are configured in the same manner as these particular exemplary components to be described, and therefore any descriptions of the rest of the circuits will be omitted for the sake of convenience.

Among the level shifter signals Ds outputted by the level shifter portion 303, the D/A conversion circuit 3040 receives and converts a corresponding level shifter signal Ds1 to an analog voltage signal Va1. Specifically, from among the analog voltage signals generated for gradation display in accordance with the reference voltages Vr from the reference voltage generating circuit 700, the D/A conversion circuit 3040 selects an analog voltage signal that corresponds to the received digital signal (the level shifter signal Ds1) in accordance with a polarity switching control signal φ, and outputs the selected signal as an analog voltage signal Va1.

As shown in FIG. 6, the D/A conversion circuit 3040 includes a resistance division circuit 3041 and a selection circuit 3042. The resistance division circuit 3041 includes first through fourth resistance groups RP0 to RP3, each consisting of a plurality of resistive elements connected in a series, so that a plurality of reference voltages Vr from the reference voltage generating circuit 700 are further divided before they are provided to the selection circuit 3042. Specifically, among the reference voltages Vr, any voltage between a first positive reference voltage VrH0 and a second positive reference voltage VrH1 is further divided by the first resistance group RP0, e.g., by sixty-four resistive elements into sixty-four tone voltages, and then provided to the selection circuit 3042. Moreover, any voltage between a first negative reference voltage VrL0 and a second negative reference voltage VrL1 is further divided as well by the fourth resistance group RP3 and then provided to the selection circuit 3042.

Here, typically, the first positive reference voltage VrH0 is equal to the +5V source voltage GVDDP provided by the 5V power circuit 810, the first negative reference voltage VrL0 is equal to the −5V source voltage GVDDN, and a midpoint voltage VrHL is equal to the ground potential GND. Accordingly, the 5V power circuit 810, which generates tone voltages, consumes more power than the 3V power circuit 820. Specifically, the 5V power circuit 810 typically includes (in addition to a divider circuit or suchlike) a booster circuit (such as a charge pump circuit) for doubling an output voltage of the 3V power circuit 820, and therefore, a reduction in current consumed by the 5V power circuit 810 leads to a reduction in power consumption. Note that also in the case where the charge pump circuit is used, the output voltage of the 3V power circuit 820 can be boosted to two and a half or three times higher, but, for example, when the voltage is doubled, current consumption is approximately doubled as well. Moreover, in the case where a switching regulator is used, current consumption is not simply doubled, for example, as is the case where the charge pump circuit is used, but the 3V power circuit 820, which consumes relatively less power, is used so that load on the 5V power circuit 810 is reduced, resulting in a reduction in current consumption, hence overall reduction in power consumption.

Note that herein, the positive reference voltage refers to a voltage to be referenced when a positive voltage relative to the common electrode Ec shown in FIG. 4 is applied to the pixel electrode Ep, and the negative reference voltage refers to a voltage to be referenced when a negative voltage relative to the common electrode Ec is applied to the pixel electrode Ep.

The analog voltage signal Va1 outputted by the D/A conversion circuit 3040 as above is inputted to its corresponding output voltage selection circuit 3050 in the output voltage selecting portion 305, and outputted as a video signal D(1) during a selection period according to a voltage selection specification signal Cs outputted by the timing control portion 310, as will be described in detail later.

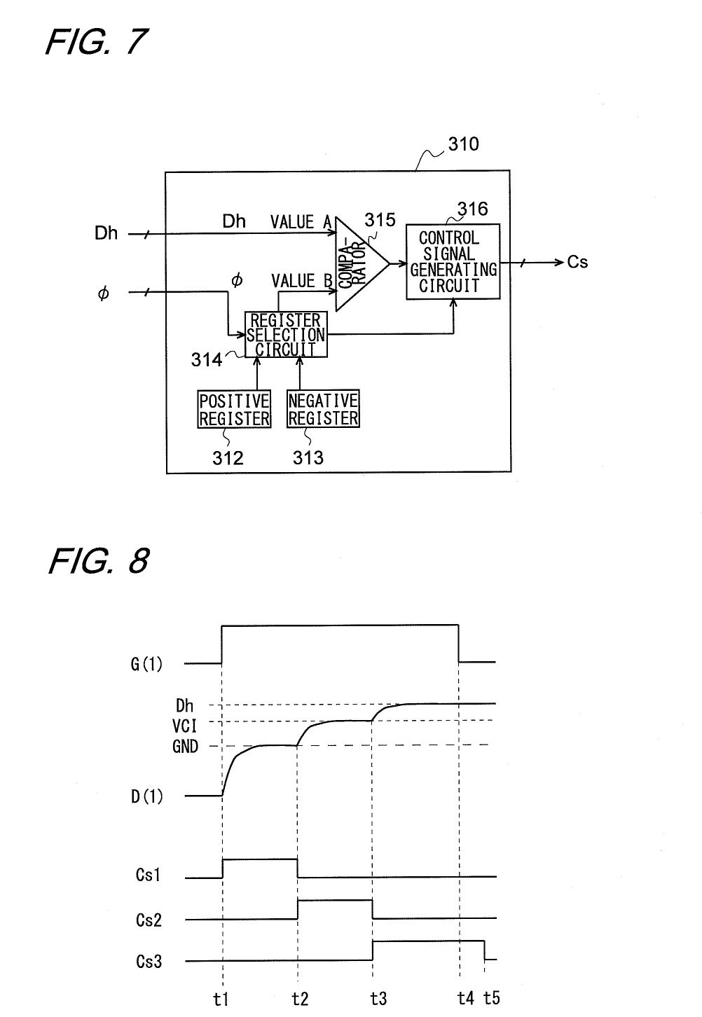

The voltage selection specification signal Cs includes a ground voltage selection specification signal Cs1 defining a period in which to select the ground voltage GND, a 3V source voltage selection specification signal Cs2 defining a period in which to select the +3V source voltage VCI or the −3V source voltage VCI1, and an analog voltage selection specification signal Cs3 defining a period in which to select the analog voltage signal Va. These selection specification signals are controlled by the timing control portion 310 so as to be ON exclusively for a predetermined period of time, and the output voltage selection circuit 3050 selects the received corresponding voltage signal during the period in which the corresponding selection specification signal is ON, and outputs the selected signal as an analog voltage signal Val. Next, the configuration of the timing control portion 310, which generates such a voltage selection signal Cs, will be described in detail with reference to FIG. 7.

<1.4.4 Configuration and Operation of the Timing Control Portion>

FIG. 7 is a block diagram illustrating details of the timing control portion 310. Note that the timing control portions 310 are provided so as to correspond to the stages of the shift register portion 301, and all of them are configured in the same manner. As shown in FIG. 7, the timing control portion 310 includes a positive register 312, a negative register 313, a register selection circuit 314, a comparator 315, and a control signal generating circuit 316.

The positive register 312 and the negative register 313 have predetermined values written therein. For example, the positive register 312 has written therein a value indicating the +3V source voltage VCI, and the negative register 313 has written therein a value indicating the −3V source voltage VCI1. However, in actuality, the voltage value Dh of the output signal Dh to be compared normally does not exactly match the value indicating the +3V source voltage VCI or the value indicating the −3V source voltage VCI1, as will be described later, and therefore, typically, predetermined voltage values Dh for the output signal Dh, which are values close to the above values and corresponding to certain tone values, are written in the positive register 312 and the negative register 313. Note that for convenience of explanation, it is assumed below that the positive register 312 has written therein the value indicating the +3V source voltage VCI and the negative register 313 has written therein the value indicating the −3V source voltage VCI1.

In accordance with the polarity switching control signal φ provided by the display control circuit 200, the register selection circuit 314 provides the comparator 315 with the value stored in the positive register 312 as value B when a positive signal is to be outputted to the video signal line Ls or with the value stored in the negative register 313 as value B when a negative signal is to be outputted. In addition, the register selection circuit 314 provides the control signal generating circuit 316 with a signal that indicates the value provided to the comparator 315 as value B being derived either from the positive register 312 or the negative register 313.

The comparator 315 receives the signal for value B provided by the register selection circuit 314 in the above manner, and also receives the voltage value Dh of the output signal Dh (here, the same character is assigned to the voltage value) outputted by the data latch portion 302 as value A, so that values A and B are compared for their magnitude correlation. The comparator 315 outputs an output value “1” when value A is greater than value B (A>B) and an output value “0” when value A is less than or equal to value B (A≦B).

Discussed first is the case where the control signal generating circuit 316 receives a signal from the register selection circuit 314 that indicates the value in the positive register 312 has been selected (the value here typically indicates the +3V source voltage VCI) and the control signal generating circuit 316 also receives an output value “1” from the comparator 315. In this case, the +3V source voltage VCI intervenes between the ground potential GND and the output signal voltage Dh, and therefore, the control signal generating circuit 316 outputs voltage selection signals Cs1 to Cs3, for example, at times shown in FIG. 8.

FIG. 8 is a diagram schematically illustrating waveforms of a scanning signal, a drive video signal, and voltage selection signals where the 3V power circuit is used. As shown in FIG. 8, when the scanning signal G(1) changes to ON potential (active) at time t1, the TFTs 10 of the pixel forming portions in the first row connected to the scanning signal line G1 are made conductive, as described earlier. Here, looking at the pixel forming portion in the first row and in the first column, a voltage selected by a corresponding output voltage selecting portion 305 is applied to the pixel electrode Ep of the pixel forming portion. Specifically, from time t1 to time t2, the ground voltage selection specification signal Cs1 is set at ON potential (active), and therefore the output voltage selecting portion 305 selects the ground voltage GND. Accordingly, the potential of the drive video signal D(1) to be outputted rises from a predetermined negative potential (before polarity inversion) to the ground potential.

Note that as described earlier, it is conventionally known that in the configuration employing the so-called dot inversion drive scheme, the ground potential GND always intervenes at the time of polarity inversion, to reduce power consumption, and in the present embodiment also, such an arrangement is included. However, the present embodiment is characterized by power consumption being reduced through the intervention of the +3V source voltage VCI or the −3V source voltage VCI1 generated by the 3V power circuit 820, as will be described later, and therefore, it is conceivable that such intervention of the ground potential GND is not provided. However, additional intervention of the ground potential GND is preferable because power consumption can be reduced more.

Subsequently, from time t2 to time t3, the 3V source voltage selection specification signal Cs2 is set at ON potential (active), and therefore, the output voltage selecting portion 305 selects the +3V source voltage VCI. Accordingly, the potential of the drive video signal D(1) being outputted rises from the ground potential to the +3V source voltage VCI. In the example shown in FIG. 8, since the +3V source voltage VCI is present between the ground potential GND and the output signal voltage Dh, as described earlier, the video signal line is driven until its potential level rises through the +3V source voltage VCI to the output signal voltage Dh, so that power consumption can be reduced.

Specifically, the 5V power circuit 810, which is used to generate the output signal voltage Dh, consumes more power than the 3V power circuit 820. Accordingly, when the video signal line is driven, power consumption is reduced as the amount of potential change (by the driving) of the video signal line driven by the 5V power circuit 810 decreases. In other words, when the amount of potential change of the video signal line driven by the 3V power circuit 820 is equal to the amount of potential change of the video signal line driven by the 5V power circuit 810, the driving by the 3V power circuit 820 consumes less power (because the aforementioned double-booster circuit and so on of the 5V power circuit 810 are not used). Therefore, when the potential level of the video signal line is changed from the ground potential GND to the +3V source voltage VCI, the driving by the 3V power circuit 820 results in lower power consumption.

Finally, from time t3 to time t4, the analog voltage selection specification signal Cs3 is set at ON potential (active), and therefore, the potential level rises to a desired point, i.e., the output signal voltage value Dh corresponding to the digital image signal Da. In this manner, power consumption can be reduced by driving the video signal line such that the potential level thereof rises from a negative potential through the ground potential GND and the +3V source voltage VCI.

Furthermore, when the control signal generating circuit 316 receives a signal from the register selection circuit 314 that indicates that the value in the negative register 313 has been selected (the value here typically indicates the −3V source voltage VCI1), and the control signal generating circuit 316 also receives an output value “0” from the comparator 315, the −3V source voltage VCI1 is present between the ground potential GND and the output signal voltage Dh. Accordingly, the voltage selection signals Cs shown in FIG. 8 can be used with similar control timing to the above, but from time t2 to time t3, the polarity switching control signal φ is negative, and therefore, the output voltage selecting portion 305 selects and outputs the −3V source voltage VCI1.

Note that strictly, the above includes a case where value A is equal to value B (A=B), and therefore, it is also preferable that a value slightly lower than the value indicating the −3V source voltage VCI1 be written in the negative register 313 such that the −3V source voltage VCI1 is present between the ground potential GND and the output signal voltage Dh.

The present embodiment has been described above with respect to the case where the value in the positive register 312 indicates the +3V source voltage VCI (which is a typical value) and the value in the negative register 313 indicates the −3V source voltage VCI1 (which is a typical value), but even in the case where neither the +3V source voltage VCI nor the −3V source voltage VCI1 is present between the ground potential GND and the output signal voltage Dh, power consumption might be reduced by the potential level transitioning through the +3V source voltage VCI or the −3V source voltage VCI1.

For example, in the case where the output signal voltage Dh is between the ground potential GND and the +3V source voltage VCI, and is closer to the +3V source voltage VCI (e.g., in the case where the output signal voltage Dh is 2.7V), when the potential of a corresponding video signal line is caused to temporarily rise from the ground potential GND to the +3V source voltage VCI and then fall (by 0.3V) to the output signal voltage Dh immediately therebelow, a total amount of potential change is higher because an excess potential change is included, but the +3V source voltage VCI can be utilized. Accordingly, when the output signal voltage Dh has a value lower than but close to the +3V source voltage VCI, power consumption for the driving can be reduced more in the case where the 3V power circuit 820 is used for a certain period of time than in the case where the 5V power circuit 810, which consumes higher power, is used in the entire period of the driving.

Accordingly, even if neither the +3V source voltage VCI nor the −3V source voltage VCI1 is set between the ground potential GND and the output signal voltage Dh, the drive mode as shown in FIG. 8 where the potential level transitions through the +3V source voltage VCI or the −3V source voltage VCI1 can be applied, so long as the difference in potential between the output signal voltage Dh and a voltage corresponding to either the +3V source voltage VCI or the −3V source voltage VCI1 is less than a predetermined amount. Note that the predetermined amount or threshold can be suitably calculated by measuring values that can achieve the effect of reducing power consumption or by performing numerical simulation.

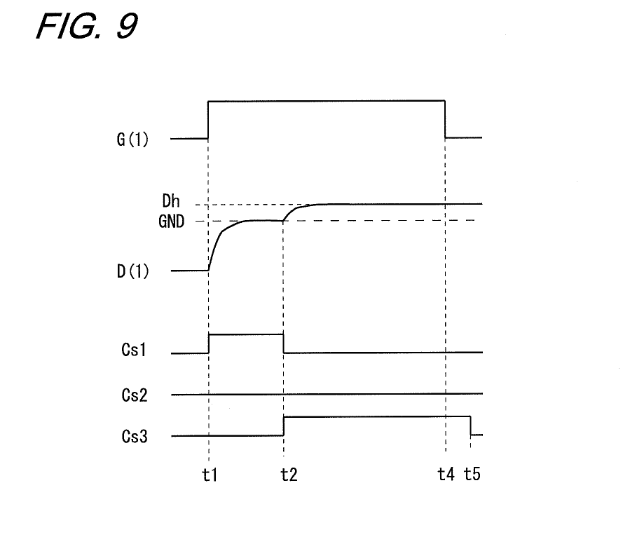

Discussed next is a case premised on the above typical example but different from the case shown in FIG. 8, specifically, where the control signal generating circuit 316 receives a signal from the register selection circuit 314 that indicates that the value in the positive register 312 has been selected (the value here indicates the +3V source voltage VCI, which is a typically value) and the control signal generating circuit 316 also receives an output value “0” from the comparator 315. In this case, the +3V source voltage VCI is not present between the ground potential GND and the output signal voltage Dh, and therefore, the control signal generating circuit 316 outputs the voltage selection signals Cs1 to Cs3 at times shown in FIG. 9. Note that if the control shown in FIG. 8 is designed to be performed even when the difference in potential between the output signal voltage Dh and the voltage corresponding to either the +3V source voltage VCI or the −3V source voltage VCI1 is less than the predetermined amount, then the following control shown in FIG. 9 is performed when the potential difference is greater than or equal to the predetermined amount.

FIG. 9 is a diagram schematically illustrating waveforms of a scanning signal, a drive video signal, and voltage selection signals where the 3V power circuit is not used. As can be appreciated by comparing FIG. 9 with FIG. 8, a 3V source voltage selection specification signal Cs2 shown in FIG. 9 is not set to ON potential (inactive), and therefore, the output voltage selecting portion 305 does not select the +3V source voltage VCI. Accordingly, the potential of the drive video signal D(1) being outputted rises from a negative potential to the ground potential GND during the period from time t1 to time t2, and further rises from the ground potential GND to the output signal voltage Dh during the period from time t2 to time t4, and therefore, in this regard, intervention of the ground potential GND can reduce power consumption as can conventionally be achieved.

Furthermore, also in the case where the control signal generating circuit 316 receives a signal from the register selection circuit 314 that indicates that the value in the negative register 313 has been selected (the value here indicates the −3V source voltage VCI1, which is a typically value), and the control signal generating circuit 316 also receives an output value “1” from the comparator 315, the +3V source voltage VCI is not present between the ground potential GND and the output signal voltage Dh. Accordingly, the voltage selection signals Cs shown in FIG. 9 can be used with similar control timing to the above, thereby achieving the effect of reducing power consumption in the manner as mentioned above.

<1.5 Effect>

As described above, in the liquid crystal display device of the present embodiment, typically, where either the +3V source voltage VCI or the −3V source voltage VCI1 is present between the ground potential GND and the output signal voltage Dh, the +3V source voltage VCI or the −3V source voltage VCI1 is initially provided to the video signal line, thereby raising (or lowering) the potential, and thereafter, the video signal line is driven (by the tone voltage generating circuit using a 5V power source) until the potential level reaches the output signal voltage Dh, so that power consumption can be reduced.

### 2. Second Embodiment

<2.1 Overall Configuration and Operation>

The configuration of a liquid crystal display device according to a second embodiment of the present invention is similar to the configuration shown in FIG. 1, the configuration and other arrangements of the liquid crystal panel 600 are similar to those shown in FIGS. 3, 4, etc., therefore, the same components are denoted by the same reference characters, and any detailed descriptions thereof will be omitted. However, the present embodiment does not employ the 1-dot inversion drive scheme as described above in conjunction with the first embodiment in which the polarity of an application voltage is inverted between any two vertically/horizontally adjacent pixels, as shown in FIG. 3, but the present embodiment employs a so-called 2-line, 2-dot inversion drive scheme in which the polarity of an application voltage is inverted every two adjacent pixels both in the vertical direction and the horizontal direction and is also inverted every frame. Note that in addition to this, a so-called 2-line, 1-dot inversion drive scheme may be employed in which every two adjacent pixels in the horizontal direction have their voltages applied in opposite polarity, as in the first embodiment, and the polarity of the application voltage is inverted every two vertically adjacent pixels, i.e., every two lines, and is also inverted every frame.

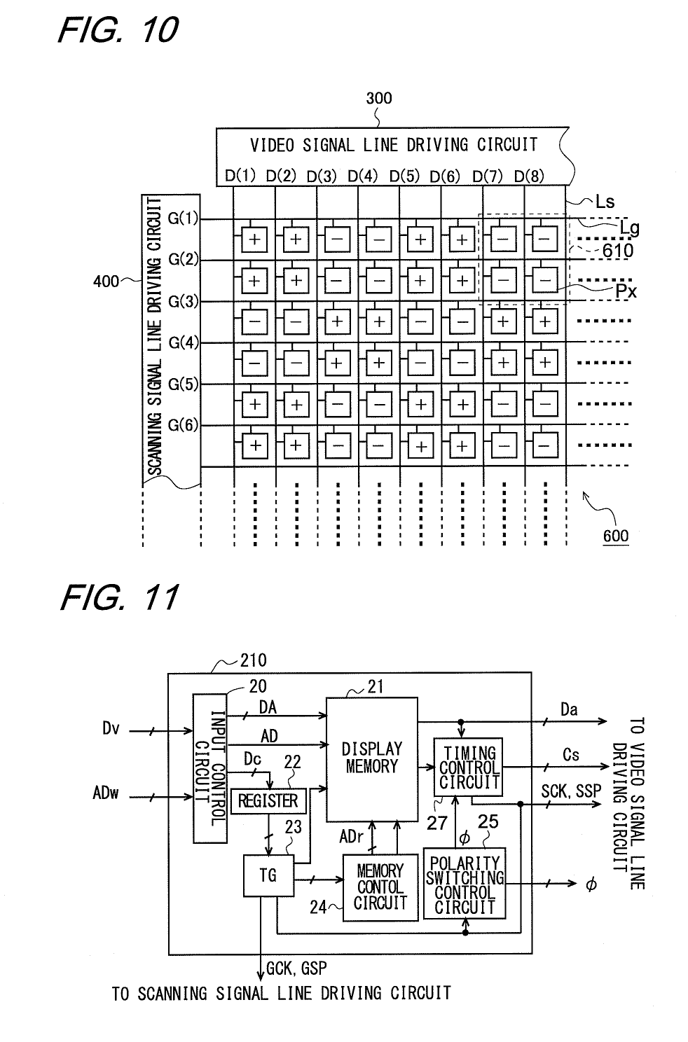

FIG. 10 is a schematic diagram illustrating the configuration of the liquid crystal panel 600 in the present embodiment. The configuration shown in FIG. 10 is similar to that shown in FIG. 3, but in FIG. 10, by referencing the signs “+” and “−” assigned to the pixel forming portions Px, it can be appreciated that the so-called 2-line, 2-dot inversion drive scheme is employed.

In the present embodiment, the shift register portion 301, the data latch portion 302, the level shifter portion 303, the D/A conversion portion 304, and the output voltage selecting portion 305 are the same as those provided in the video signal line driving circuit 300 of the first embodiment shown in FIG. 5, but the timing control portion 310 is omitted, and instead, a display control circuit 210 includes a component having the same function as the timing control portion 310. Hereinafter, referring to FIG. 11, the configuration and the operation of the display control circuit 210 will be described in detail for its characteristic difference from the display control circuit 200 of the first embodiment.

<2.2 Configuration and Operation of the Display Control Circuit>

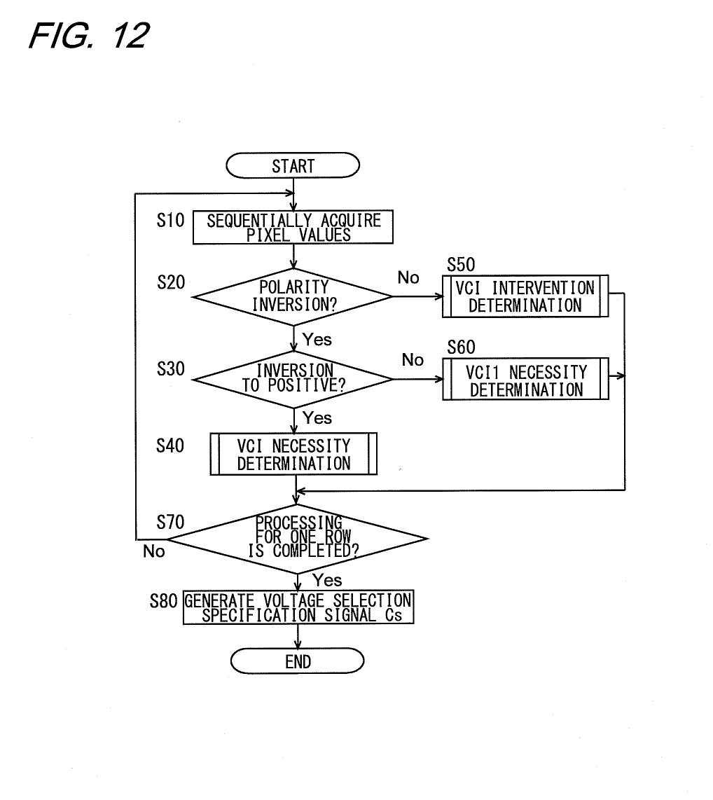

FIG. 11 is a block diagram illustrating the configuration of the display control circuit in the present embodiment. The display control circuit 210 shown in FIG. 11 includes a timing control circuit 27, in addition to the input control circuit 20, the display memory 21, the register 22, the timing generating circuit 23, the memory control circuit 24, and the polarity switching control circuit 25 as included in the display control circuit 200 of the first embodiment shown in FIG. 2. Accordingly, the same components as in the first embodiment are denoted by the same reference characters, and any descriptions thereof will be omitted; the operation of the timing control circuit 27 will be described in detail with reference to FIGS. 11 and 12.

As with the timing control portion 310 of the first embodiment, the timing control circuit 27 shown in FIG. 11 provides the voltage selection specification signals Cs to the output voltage selecting portion 305 included in the video signal line driving circuit 300, but instead of receiving the output signal Dh from the data latch portion 302, the timing control circuit 27 receives a source driver digital image signal Da and a signal indicating the row for which the data is intended, which are outputted by the display memory 21. On the basis of the received signals, the timing control circuit 27 determines whether or not to set any one of the ground potential GND, the +3V source voltage VCI, and the −3V source voltage VCI1 in accordance with the procedure shown in FIG. 12, and outputs a corresponding voltage selection specification signal Cs.

FIG. 12 is a flowchart illustrating the flow of the procedure for the timing control circuit 27 to determine the voltage selection specification signal Cs. Note that this procedure is defined by hardware such as logic circuits, but it may be defined by software described in a predetermined program language or suchlike.

In step S10 shown in FIG. 12, the timing control circuit 27 sequentially (column by column from the first column) acquires pixel values included in the digital image signal Da from the display memory 21. Next, in step S20, the timing control circuit 27 determines whether or not to perform polarity inversion on a corresponding video signal line connected to pixel forming portions to be provided with the acquired pixel values. Since the present embodiment employs the 1-line, 2-dot inversion drive scheme, as described earlier, polarity inversion of the video signal line occurs every odd row. Accordingly, specifically, when pixel values are provided to pixel forming portions in even rows, it can be determined that polarity inversion does not occur, and when pixel values are provided to pixel forming portions in odd rows, it can be determined that polarity inversion occurs. Therefore, when polarity inversion is determined to occur (Yes in step S20), the procedure advances to step S30, and when polarity inversion is determined to not occur (No in step S20), the procedure advances to a VCI intervention determination process of step S50. In the VCI intervention determination process (S50), it is determined whether or not the output voltage selecting portion 305 connected to the corresponding video signal line should select and output the +3V source voltage VCI. Details of the process will be described later. Thereafter, the procedure advances to step S70.

Subsequently, in step S30, the timing control circuit 27 determines whether or not the polarity of the corresponding video signal line is inverted from negative to positive. This can be readily determined by referencing the polarity switching control signal φ from the polarity switching control circuit 25. Moreover, in the case where the inversion is from negative to positive (Yes in step S30), the procedure advances to a VCI necessity determination process of step S40, or in the case where the inversion is from positive to negative (No in step S30), the procedure advances to a VCI1 necessity determination process of step S60. Note that details of the VCI necessity determination process (S40) and the VCI1 necessity determination process (S60) will be described later. Thereafter, the procedure advances to the step S70.

Next, in step S70, the timing control circuit 27 determines whether or not processing for one row has already been completed. In the case where processing for one row has already been completed (Yes in step S70), the procedure advances to step S80, and in the case where the processing has not yet been completed (No in step S70), the procedure returns to step S10 to repeat therefrom until the processing for one row is completed (S70→S10→ . . . →S70).

Subsequently, in step S80, to the output voltage selecting portion 305, the timing control circuit 27 outputs a voltage selection specification signal Cs to the output voltage selecting portion 305 coupled to the corresponding video signal line, on the basis of the results of the VCI intervention determination process (S50), the VCI necessity determination process (S40), and the VCI1 necessity determination process (S60). Note that here, output signal voltages Dh corresponding to all video signal lines are typically determined in accordance with latch signals, as described earlier, and therefore, voltage selection specification signals Cs corresponding to all video signal lines are outputted row by row, but the voltage selection specification signals Cs may be outputted column by column (one by one of all of the video signal lines). Thereafter, the series of processing steps is completed, another series of processing steps is started for the next row. Note that when the processing for the last row is completed, another series of processing steps is started from the first row of an image in the next frame. Next, the VCI necessity determination process (S40) will be described in detail.

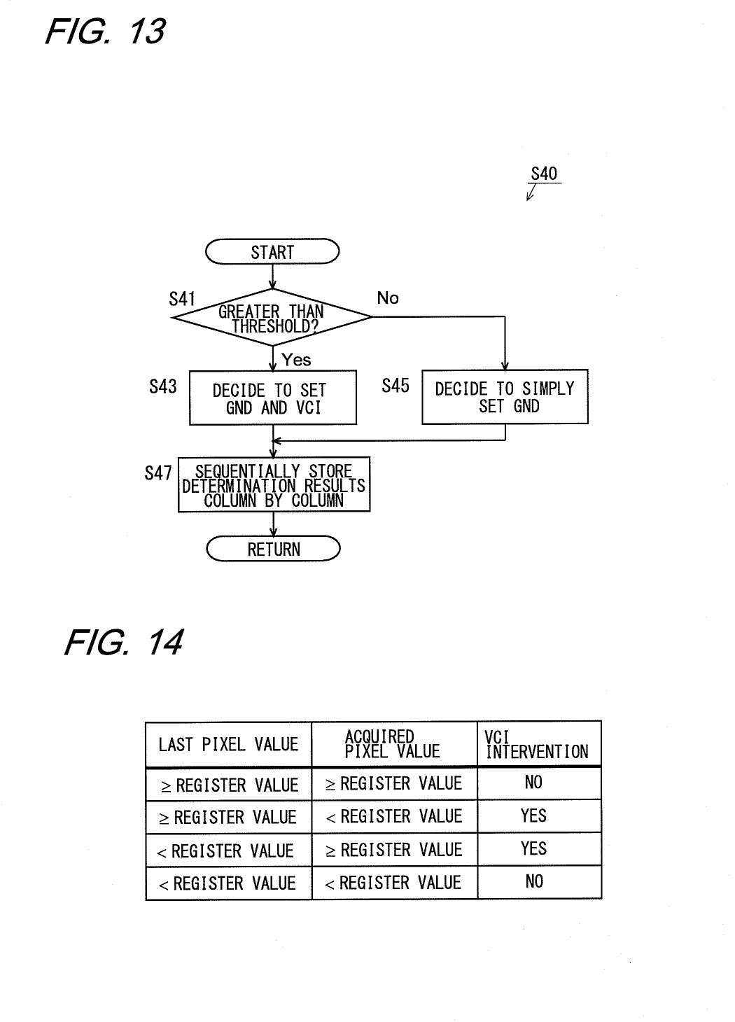

FIG. 13 is a flowchart illustrating in detail the flow of the procedure for the VCI necessity determination process (S40). In step S41 shown in FIG. 13, the timing control circuit 27 determines whether or not an acquired (in step S10 shown in FIG. 12) pixel value is greater than a predetermined threshold. When the determination result is that the value is greater than the threshold (Yes in step S41), the timing control circuit 27 decides in step S43 to set the ground potential GND and the +3V source voltage VCI, and when the value is less than or equal to the threshold (No in step S41), the timing control circuit 27 decides in step S45 to simply set the ground potential GND, and the procedure advances to step S47. Here, the threshold is a pixel value that corresponds to the register value stored in the positive register 312, which has been described earlier in the first embodiment, and the above determination is equivalent to the comparing determination by the comparator 315 (and the control signal generating circuit 316). Note that as in the first embodiment, the register value is a tone value close to the value that indicates the +3V source voltage VCI, but it may be, for example, 128 (among all 256 tones) such that the determination here can be readily made by bit comparison. As a result, an easy determination can be made by comparing the most significant bits between two sets of eight bits. In addition, the register value may be 64, 128, or 192. As a result, an easy determination can be made by comparing two high-order bits between two sets of eight bits.

In step S47, the timing control circuit 27 sequentially stores the results determined in step S43 or S45 column by column, i.e., one by one of all of the video signal lines (in accordance with the acquired pixel values). Thereafter, the procedure returns to the process shown in FIG. 12, where the determined results stored in step S47 are referenced in step S80 after the processing for one row is determined in step S70 to be completed, as described earlier in conjunction with FIG. 12, so that a voltage selection specification signal Cs is outputted to the output voltage selecting portion 305 coupled to the corresponding video signal line.

In this manner, the voltage selection specification signal Cs outputted here is the same as in the first embodiment. Specifically, when the decision in step S43 is to set both the ground potential GND and the +3V source voltage VCI, the timing shown in FIG. 8 is applied, and when the decision in step S45 is to simply set the ground potential GND, the timing shown in FIG. 9 is applied.

Furthermore, the VCI1 necessity determination process of step S60 shown in FIG. 12 is the same as the VCI necessity determination process of step S40, except that the output signal voltage Dh is lower than the ground potential GND, the −3V source voltage VCI1 is used, and the magnitude correlation is determined from the opposite viewpoint because the sign is opposite. Since the procedure is almost the same, details of the VCI1 necessity determination process of step S60 can be readily understood with reference to the flow of the procedure shown in FIG. 13, and any descriptions thereof will be omitted.

Next, in the VCI intervention determination process of step S50 shown in FIG. 12, the polarity is not inverted (from that of the previous row), and therefore, unlike in the case where polarity inversion occurs, as in the VCI1 necessity determination process of step S60 and the VCI necessity determination process of step S40, the potential level does not transition through the ground potential GND. This is because, when no polarity inversion occurs, if the potential level transitions through the ground potential GND, the total amount of potential change unnecessarily increases. Accordingly, here, only the +3V source voltage VCI or the −3V source voltage VCI1 is set or no predetermined potential is set at all. For example, the determination is made as shown in FIG. 14.

FIG. 14 is a table showing conditions under which to determine whether or not to set the +3V source voltage VCI in the VCI intervention determination process. Here, the threshold is a pixel value that corresponds to the register value stored in the positive register 312, which has been described earlier in the first embodiment, and the above determination is equivalent to the comparing determination by the comparator 315 (and the control signal generating circuit 316). Specifically, when both the last pixel value (the pixel value provided to the video signal line targeted in the previous row) and the pixel value acquired in step S10 (the pixel value to be provided to the video signal line currently targeted) are greater than or equal to a positive register value (typically, a pixel value corresponding to 3V) or when both of them are less than that positive register value, the potential of the target video signal line does not transition through the +3V source voltage VCI. Accordingly, here, the +3V source voltage VCI is not set, in order not to unnecessarily increase the total amount of potential change.

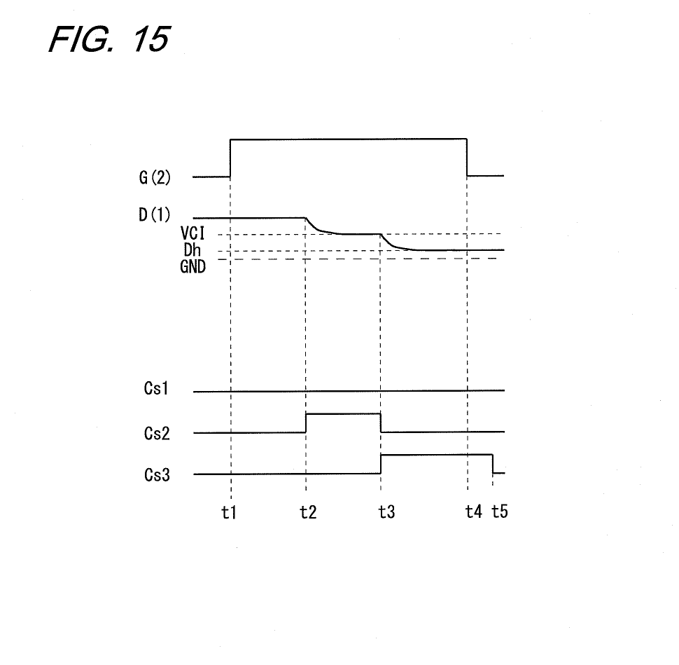

Furthermore, when the last pixel value is greater than or equal to the positive register value, and the acquired pixel value is less than the positive register value, or when the last pixel value is less than the positive register value, and the acquired pixel value is greater than or equal to the positive register value, the potential of the target video signal line transitions through the +3V source voltage VCI. Accordingly, here, the +3V source voltage VCI is set. In this manner, when the +3V source voltage VCI is set, the voltage selection specification signals Cs1 to Cs3 follow the timing shown in FIG. 15, for example.

FIG. 15 is a diagram schematically illustrating waveforms of a scanning signal, a drive video signal, and voltage selection signals where the 3V power circuit is used in the present embodiment. As shown in FIG. 15, when the scanning signal G(2) changes to ON potential (active) at time t1, the TFTs 10 of the pixel forming portions in the second row connected to the scanning signal line G2 are made conductive, as described earlier. Here, looking at the pixel forming portion in the second row and in the first column, the polarity of the pixel forming portion is not inverted (from that in the first row) since the row is even. Here, at time t1, a voltage selected by a corresponding output voltage selecting portion 305 is applied to the pixel electrode Ep of the pixel forming portion, but the voltage selection specification signals Cs1 to Cs3 are all at OFF potential (inactive), as shown in FIG. 15. Accordingly, there is no voltage to be selected and applied, and therefore, during the period from time t1 to time t2, there is no potential change from the level immediately before time t1.

Subsequently, at time t2, the 3V source voltage selection specification signal Cs2 changes to ON potential (active), so that the output voltage selecting portion 305 selects the +3V source voltage VCI. As a result, the potential of the drive video signal D(1) being outputted falls from the immediately prior potential of the target video signal line to the +3V source voltage VCI.

Thereafter, at time t3, the output voltage selecting portion 305 selects the output signal voltage Dh, so that the potential of the drive video signal D(1) being outputted falls from the +3V source voltage VCI to the output signal voltage Dh. In this manner, the +3V source voltage VCI is present between the immediately prior potential of the target video signal line and the output signal voltage Dh, and therefore, by driving the video signal line such that the potential level changes through the +3V source voltage VCI to the output signal voltage Dh, power consumption can be reduced.

<2.3 Effect>

As described above, in the liquid crystal display device of the present embodiment, typically, when the +3V source voltage VCI or the −3V source voltage VCI1 is present between the immediately prior potential of the video signal line and the output signal voltage Dh, the +3V source voltage VCI or the −3V source voltage VCI1 is initially applied to the video signal line, thereby raising (or lowering) the potential, and the video signal line is driven (by the tone voltage generating circuit using a 5V power source) until the potential level reaches the output signal voltage Dh, thereby reducing power consumption.

### 3. Variant

While the first embodiment employs the 1-dot inversion drive scheme, and the second embodiment employs the 2-line, 2-dot inversion drive scheme, an n-dot inversion drive scheme (where n is a natural number of 3 or more) may be employed in which the polarity of an application voltage is inverted every n adjacent pixel forming portions in the horizontal direction. In addition, the present invention can be applied as well to an m-line, 2-dot or m-line, n-dot inversion drive scheme (where m is a natural number of 3 or more) in which the polarity of an application voltage is inverted every m adjacent pixel forming portions in the vertical direction.

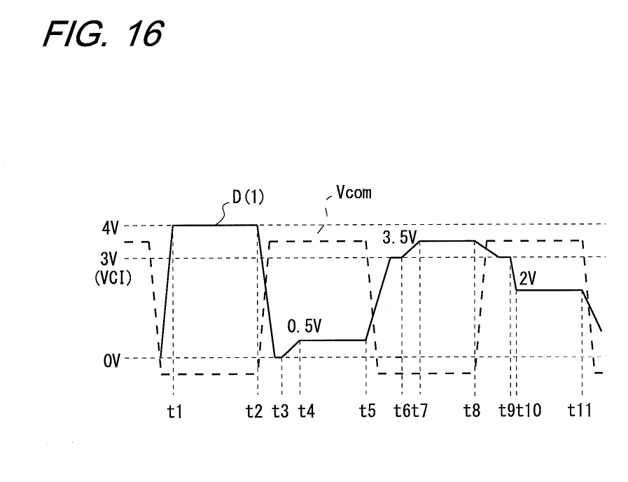

Furthermore, in addition to such dot inversion drive schemes as employed in the first and second embodiments, the present invention can be applied as well to configurations where the common electrode is subjected to inversion drive (i.e., two different potentials are alternatingly provided) as in the line inversion drive scheme (or frame inversion drive scheme). Details will be described below with reference to FIG. 16.

FIG. 16 is a diagram schematically illustrating waveforms of a common potential and a drive video signal where the 3V power circuit is used in a variant as described above. As shown in FIG. 16, the voltage of the drive video signal D(1) at time t1 is 4V, and the common potential Vcom at this time is −0.5V.

At time t2, the common electrode is subjected to inversion drive, so that the common potential Vcom rises toward 3.5V. In this case, to apply a tone voltage to a pixel forming portion positioned in the next row that correspond to the same video signal line, the ground potential GND, rather than a corresponding drive video signal D(1) having a tone voltage of 0.5V, is provided, so that the potential of the video signal line falls toward 0V. Specifically, at time t2, the ground voltage selection specification signal Cs1 is activated, so that the output voltage selection circuit 3050 outputs the drive video signal D(1) at 0V, as described earlier. In this manner, by using the ground potential GND, power consumption can be reduced in the same manner as described above.

At time t3, the analog voltage selection specification signal Cs3 is activated, so that the output voltage selection circuit 3050 outputs the drive video signal D(1) having the same potential as an analog voltage signal Va (here, 0.5V), as described earlier. Thereafter, at time t4, the potential of the corresponding video signal line reaches 0.5V before the corresponding pixel forming portion is deselected and tone voltage application thereto ends.

At time t5, the common electrode is subjected to inversion drive, so that the common potential Vcom falls toward −0.5V. In this case, to apply a tone voltage to a pixel forming portion positioned in the next row that correspond to the same video signal line, the +3V source voltage VCI, rather than a corresponding drive video signal D(1) having a tone voltage of 3.5V, is provided, so that the potential of the video signal line rises toward 3V. Specifically, at time t5, the 3V source voltage selection specification signal Cs2 is activated, so that the output voltage selection circuit 3050 outputs the drive video signal D(1) at 3V, as described earlier. In this manner, by using the +3V source voltage VCI, power consumption can be reduced in the same manner as described in the above embodiment.

At time t6, the analog voltage selection specification signal Cs3 is activated, so that the output voltage selection circuit 3050 outputs the drive video signal D(1) having the same potential as the analog voltage signal Va (here, 3.5V), as described earlier. Thereafter, at time t7, the potential of the corresponding video signal line reaches 3.5V before the corresponding pixel forming portion is deselected and tone voltage application thereto ends.

At time t8, the common electrode is subjected to inversion drive, so that the common potential Vcom rises toward +3.5V. In this case, to apply a tone voltage to a pixel forming portion positioned in the next row that correspond to the same video signal line, the +3V source voltage VCI, rather than a corresponding drive video signal D(1) having a tone voltage of 2V, is provided, so that the potential of the video signal line falls toward 3V. Specifically, at time t8, the 3V source voltage selection specification signal Cs2 is activated, so that the output voltage selection circuit 3050 outputs the drive video signal D(1) at 3V, as described earlier. In this manner, by using the +3V source voltage VCI, power consumption can be reduced in the same manner as described in the above embodiment.

At time t9, the analog voltage selection specification signal Cs3 is activated, so that the output voltage selection circuit 3050 outputs the drive video signal D(1) having the same potential as the analog voltage signal Va (here, 2V), as described earlier. Thereafter, at time t10, the potential of the corresponding video signal line reaches 2V before the corresponding pixel forming portion is deselected. Subsequently, at time t11, the common electrode is subjected to inversion drive, and similar operations to the above are repeated.

In this manner, even when the common electrode is driven, if, for example, the immediately prior potential of the drive video signal D(1) is 1.0V or more, and the potential of the drive video signal D(1) that corresponds to the next tone voltage to be outputted is 0.5V or less, as described above, the ground voltage selection specification signal Cs1 is activated, so that the output voltage selection circuit 3050 outputs the drive video signal D(1) at 0V, and if, for example, the potential of the drive video signal D(1) that corresponds to the next tone voltage to be outputted is in the range of from 2.5V to 3.5V, the 3V source voltage selection specification signal Cs2 is activated, so that the output voltage selection circuit 3050 outputs the drive video signal D(1) at 3V. As a result, as in the above embodiment, power consumption can be reduced more than in the case where the tone voltage generating circuit only using a 5V power source drives video signal lines.

In the second embodiment, the output voltage selection circuit in the video signal line driving circuit provided for each video signal line is controlled, but in such a configuration, signal lines for transmitting the voltage selection specification signals Cs1 to Cs3 are required to be provided in the same number as the video signal lines. Therefore, since the timing of each signal is common among all the video signal lines, three signal lines for transmitting the voltage selection specification signals Cs1 to Cs3 may be commonly provided, the timing control portion 310 may generate a control signal indicating which voltage selection specification signal is to be received, and transmit the control signal to each of the output voltage selection circuits. Moreover, by using this configuration with a well-known serial data communication technique, the number of signal lines for transmitting the control signals can be further reduced.

In the first embodiment, the timing control portion 310 is provided in the video signal generating circuit, but it may be provided in the display control circuit so as to receive a pixel value from the display memory, rather than a latch data value, as in the second embodiment. Moreover, in the second embodiment, the timing control circuit 27 is provided in the display control circuit, but it may be provided in the display control circuit so as to receive a latch data value from the data latch portion, rather than a pixel value from the display memory, as in the first embodiment.

In the first embodiment, the data latch portions 302, the level shifter portions 303, the D/A conversion portions 304, and the output voltage selecting portions 305 are provided one for each stage of the shift register portion 301, but they may be provided in a total of two each, one for positive polarity, and the other for negative polarity. Moreover, in the first embodiment, these components are provided one for each corresponding video signal line, but they may be provided in two or more for each video signal line. Such a configuration employs a so-called multiple-source time division scheme in which each video signal line is driven by one of the components in a time division manner. Note that such a configuration can be employed in the second embodiment as well.

In the first or second embodiment, the ground voltage GND, the +3V source voltage VCI, and the −3V source voltage VCI1 can be selected in accordance with the voltage selection specification signals Cs, but another predetermined output, such as a regulator output or a power circuit output, may further be selectable. For example, a 1.8V power circuit output or a 1.0V or 2.0V regulator output (based on a 1.8V or 3.0V power circuit output) may be used. As the number of selectable constant potentials increases, chip area increases due to addition of switching circuits and wiring, but power consumption can be further reduced compared to the embodiments.

### INDUSTRIAL APPLICABILITY

The present invention relates to active-matrix display devices, and is suitable for video signal line driving circuits provided in display devices such as active-matrix liquid crystal display devices.

1. A video signal line driving circuit in a display device for receiving an image signal representing an image and applying voltages to a plurality of video signal lines in accordance with the image signal, the display device including pixel electrodes provided in a plurality of pixel forming portions arranged in a matrix so as to correspond to intersections of the video signal lines and a plurality of scanning signal lines in a display portion for displaying the image, a common electrode opposed to the pixel electrodes so as to apply voltage to the pixel electrodes, a first power source for providing a first voltage, and a second power source for providing a second voltage having a greater magnitude than the first voltage, the driving circuit comprising:
a tone voltage generating circuit for generating a plurality of tone voltages to be applied to the video signal lines based on the second power source;
a conversion circuit for converting the generated tone voltages and outputting signals indicative of pixel values included in the image signal that are to be provided to the pixel forming portions; and
an output circuit for providing a signal voltage outputted by the conversion circuit to a target video signal line for supplying the pixel forming portion with a signal voltage to be outputted by the conversion circuit when a threshold voltage that is set in accordance with the first voltage is not present between the signal voltage to be outputted by the conversion circuit and an immediately previous voltage of the target video signal line, wherein the output circuit provides the first voltage to the target video signal line during a first predetermined period when the threshold voltage is present, and after a lapse of the first period, the output circuit provides the signal voltage outputted by the conversion circuit to the target video signal line.

2. The video signal line driving circuit according to claim 1, wherein,
the tone voltage generating circuit generates a plurality of tone voltages including positive and negative voltages relative to a constant potential of the common electrode,
every predetermined polarity inversion period, the conversion circuit alternatingly selects a positive or negative tone voltage corresponding to the image signal from the generated tone voltages, and outputs the selected voltage such that the polarity of the voltage applied to the pixel electrode relative to a constant potential is inverted every predetermined polarity inversion period, the constant potential being a potential equal or close to the potential of the common electrode, and
when the constant potential is present between the signal voltage outputted by the conversion circuit and the immediately previous voltage of the target video signal line, the output circuit provides the constant potential to the target video signal line during a second predetermined period, and after a lapse of the second period, the output circuit provides the signal voltage outputted by the conversion circuit to the target video signal line.

3. The video signal line driving circuit according to claim 2, wherein, when the constant potential is present between the signal voltage outputted by the conversion circuit and the immediately previous voltage of the target video signal line, and the threshold voltage is present between the constant potential and the signal voltage outputted by the conversion circuit, the output circuit provides the target video signal line with the constant potential during the second period, the first voltage during the first period immediately after a lapse of the second period, and then the signal voltage outputted by the conversion circuit after a lapse of the first period.

4. The video signal line driving circuit according to claim 3, wherein,
the conversion circuit alternatingly selects a positive or negative tone voltage relative to the constant potential, and outputs the selected voltage such that the polarities of pixel electrodes provided in two adjacent pixel forming portions respectively are different and inverted, and
the output circuit provides the target video signal line with the constant potential during the second period, and also provides the target video signal line with the first voltage during the first period immediately after a lapse of the second period, and then the signal voltage outputted by the conversion circuit after a lapse of the first period, when the threshold voltage is present between the constant potential and the signal voltage outputted by the conversion circuit.

5. The video signal line driving circuit according to claim 1, wherein the magnitude of the threshold voltage is close to but greater than the magnitude of the first voltage.

6. An active-matrix display device, comprising:
a video signal line driving circuit of claim 1;
a scanning signal line driving circuit for selectively driving the scanning signal lines;
a display control circuit for generating tone signals indicative of tones that correspond to an image signal representing the image and provided from outside the device; and
a common electrode driving circuit for providing a predetermined potential to the common electrode.

7. A method for driving a video signal line in a display device by receiving an image signal representing an image and applying voltages to a plurality of video signal lines in accordance with the image signal, the display device including pixel electrodes provided in a plurality of pixel forming portions arranged in a matrix so as to correspond to intersections of the video signal lines and a plurality of scanning signal lines in a display portion for displaying the image, a common electrode opposed to the pixel electrodes so as to apply voltage to the pixel electrodes, a first power source for providing a first voltage, and a second power source for providing a second voltage having a greater magnitude than the first voltage, the method comprising:
a tone voltage generation step of generating a plurality of tone voltages to be applied to the video signal lines based on the second power source;
a conversion step of converting the generated tone voltages and outputting signals indicative of pixel values included in the image signal that are to be provided to the pixel forming portions; and
an output step of providing a signal voltage outputted in the conversion step to a target video signal line for supplying the pixel forming portion with a signal voltage to be outputted in the conversion step when a threshold voltage that is set in accordance with the first voltage is not present between the signal voltage to be outputted in the conversion step and an immediately previous voltage of the target video signal line, wherein the first voltage is provided to the target video signal line during a first predetermined period when the threshold voltage is present, and after a lapse of the first period, the signal voltage outputted by the conversion step is provided to the target video signal line.
